(19) United States
(12) Patent Application Publication
(10) Pub. No.: US 2009/0056219 A1
(43) Pub. Date: Mar. 5, 2009

(54) SELF-WATERING PLANT CONTAINER

(76) Inventor: Lajos Csoke, Toronto (CA)

Correspondence Address: SAND & SEBOLT, AEGIS TOWER, SUITE 1100, 4940 MUNSON STREET, NW, CANTON, OH, 44718-3615, US

(21) Appl. No.: 11/850,379

(22) Filed: Sep. 5, 2007

(51) Int. Cl. A01G 27/02

(52) U.S. Cl. 47/79

(57) ABSTRACT

A self-watering plant container for a flower pot. The container base defines a cavity for holding the flower pot and an interior chamber for retaining water therein. The base has a first aperture in its outer wall that opens into the chamber and water is introduced therethrough. A plug seals the same. A channel extends between the chamber and cavity allowing water to flow therebetween. Water accumulates in the cavity and flows through openings in the bottom of the flower pot. The base includes a second aperture through which a hollow tube extends into the chamber. The tube provides a mechanism for bringing the system into equilibrium by permitting atmospheric air pressure to balance the water levels in the chamber and cavity. The container includes an electronic sensor that transmits a signal to a remote electronic device to indicate when water must be added to the container.

### BACKGROUND OF THE INVENTION

1. Technical Field

This invention generally relates to gardening. More particularly, the invention relates to plant containers. Specifically, the invention relates to a self-watering plant container that includes a water retaining chamber having a tube inserted therein to allow for atmospheric regulation of the water level in the chamber and in an adjacent flower pot-retaining cavity in the container.

2. Background Information

The common and basic approach to watering plants is to do so in timely intervals, adding water manually to either the surface of the soil or to a water trap positioned beneath the container. At the time of watering, the soil is soaked to the point of saturation. Water is gradually withdrawn from the soil by the plant and additional water evaporates from the soil into the air. After several days, the soil drys out and then the over-saturated watering takes place yet again. The watering and drying cycles tend to shock the plant in the container and reduces the chances of the plant flourishing. It would be preferable to have a system in which a constant level of hydration is experienced. That way, the plant has a steady supply of water from which to draw and does not experience the cyclical shock of over-watering followed by drought.

Several prior art patents have addressed this issue and have disclosed a variety of self-watering plant containers. One such device is disclosed in U.S. Pat. No. 4,219,967 issued to Hickerson. Hickerson discloses a base having a liquid retaining reservoir therein. A separate flower pot container is provided to interlock in a recess in the base. The flower pot container interlocks with a lip in the upper surface of the reservoir and extends upwardly and outwardly away from the upper surface of the reservoir. The flower pot container includes an aperture in its lower surface. An absorbent pad is provided. A first portion of the pad is retained within the reservoir in the base and a second portion of the pad rests on the interior surface of the flower pot container. A flower pot is received within the flower pot container and rests on the second portion of the pad. The first portion of the pad absorbs liquid from the reservoir and transmits the same to the second portion of the pad in the interior of the flower pot container. As the flower pot includes an opening in its bottom wall, water is transmitted from the second portion of the pad into the soil retained within the flower pot. The reservoir includes a lateral channel through which water may be introduced into the reservoir.

U.S. Pat. No. 4,244,147 issued to Geddes discloses a flower pot holder that includes a base and a flower pot container retained within the base. The base includes a liquid reservoir. The flower pot container includes an enlarged opening in its bottom wall that is in communication with the reservoir. An absorbent pad is placed on the interior bottom wall of the container and between the interior bottom wall and a flower pot. A wick extends between the absorbent pad and the reservoir. The base is bulbous at its upper end, includes a narrow vertical section and a wider bottom support. The base includes a weight to ensure that the top-heavy base does not accidentally fall over.

U.S. Pat. No. 4,343,109 issued to Holtkamp discloses a self-watering plant container. The container comprises a base that includes an open reservoir therein. Base further includes a shelf that is retained a spaced distance above the bottom interior surface of the base. The shelf is supported on a plurality of legs that extend downwardly to engage the bottom interior surface of the base. The upper surface of the shelf is provided with an absorbent pad. The upper surface of the shelf further includes an aperture therein. A portion of the absorbent pad is detached from the remainder of the pad and extends downwardly through the aperture and into liquid retained within the reservoir. As with the previously described flower pots, water travels up through the wick portion of the absorbent pad and saturates the pad resting on the shelf. A flower pot is positioned on the absorbent pad and water is transmitted through apertures in the base of the flower pot and into the soil retained therein.

U.S. Pat. No. 4,932,159 issued to Holtkamp, Sr. discloses a wick insert that is placed into the opening in the bottom of a flower pot. A length of the wick insert extends outwardly from the opening and is placed into a reservoir. Liquid from the reservoir moves up the wick by capillary action and into the soil in the flower pot.

Canadian Patent No. 2028721 issued to Cavallaro et al discloses an outer container which acts as a reservoir. An inner container is engaged with the outer container and is configured to retain the flower pot therein. The inner container has a hole in its base and a length of a wick is inserted through the hole and into the liquid retained in the outer container. A length of the wick is coiled and rests on the interior surface of the inner container. The flower pot is placed on top of the coiled wick and water moves through the wick and into the soil by capillary action. The inner container may also include an aperture in its upper surface for air circulation.

Canadian Patent No. 2330059 issued to Lai discloses a flower pot container comprising a transparent outer wall and a concave inner wall. A soil holder is retained within the concave portion of the inner wall and the soil and plant are placed on an upper surface of the soil holder. A chamber for retaining water is defined between the inner and outer walls. The soil holder comprises a disk that has air vents extending through it and a plurality of water holes that extend between an upper and a lower chamber. The upper chambers of the soil holder retain a quantity of soil therein. The inner wall defines a hole through which a small tube is inserted. Water flows through the hole and tube from the chamber, into the lower chambers of the soil holder and then through the holes therein into the upper chambers of the soil holder. A float mechanism is attached to the tube to regulate the water flow into the inner pot and thereby controls the amount of water that is transmitted into the soil in the upper chambers of the soil holder. The outer and inner pots have nesting tubes to permit air to flow from the outside into the concave region of the inner wall and beneath the soil holder.

There is therefore a need in the art for an improved self-watering plant container that is free of wicks and is regulated by the plant's consumption of water in the soil.

### SUMMARY OF THE INVENTION

The device of the present invention comprises a self-watering plant container for retaining a flower pot therein. The container includes a base defining a cavity for holding the flower pot therein. The base further defines an interior chamber for retaining a quantity of water and has a first aperture in its outer wall that opens into the chamber. Water is introduced into the chamber through the first aperture and a plug is used to seal the same. At least one channel extends between the chamber and the cavity to permit flow of water therebetween. Water accumulates in the bottom of the cavity and is able to flow into openings in the bottom end of the flower pot. The base also includes a second aperture through which an elongated hollow tube extends into the interior of the chamber. The end of the tube is disposed a spaced distance away from the interior bottom surface of the base. The tube provides a mechanism for bringing the system into equilibrium by permitting atmospheric air pressure to balance the water levels in the chamber and cavity. The container preferably includes an electronic sensor that transmits a signal to a remote electronic device to provide warning that the water level in the container has dropped below a preset value.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective view of the self-watering plant container in accordance with the present invention;

FIG. 2 is an exploded perspective view of the container of FIG. 1;

FIG. 3 is a cross-sectional front view of the container;

FIG. 4 is an enlarged partial cross-sectional front view of the plant container showing the effect of atmospheric pressure through the tube;

FIG. 5 is a cross-sectional front view of a second embodiment of a self-watering plant container in accordance with the present invention;

FIG. 6 is a cross-sectional front view of a third embodiment of a self-watering plant container in accordance with the present invention; and

FIG. 7 is a cross-sectional front view of a fourth embodiment of a self-watering plant container in accordance with the present invention.

### DETAILED DESCRIPTION OF THE INVENTION

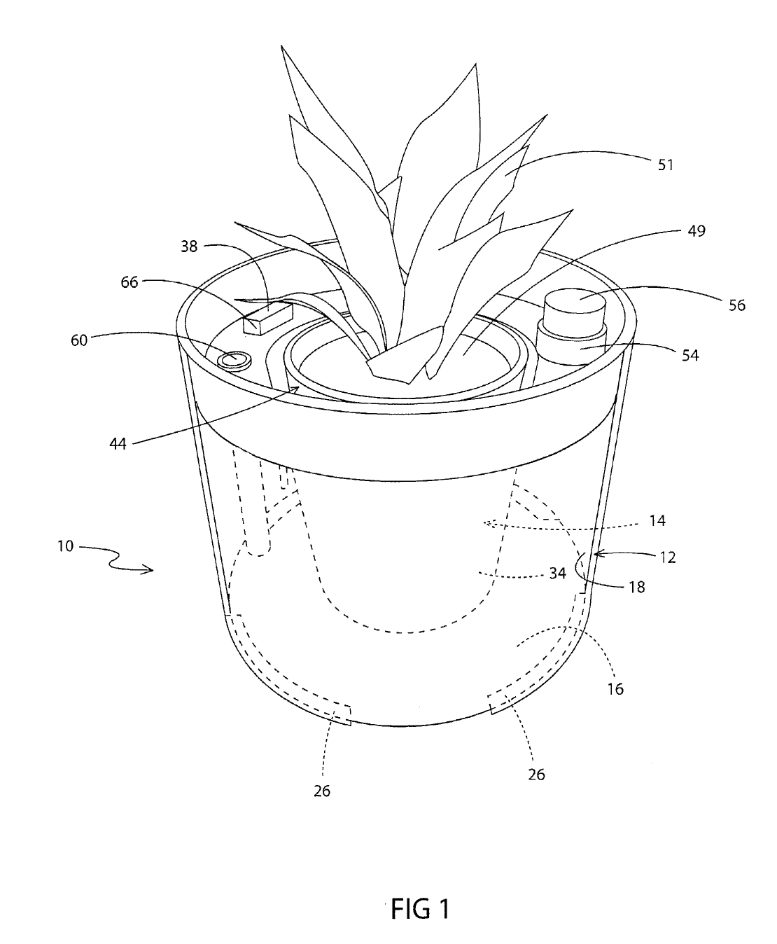

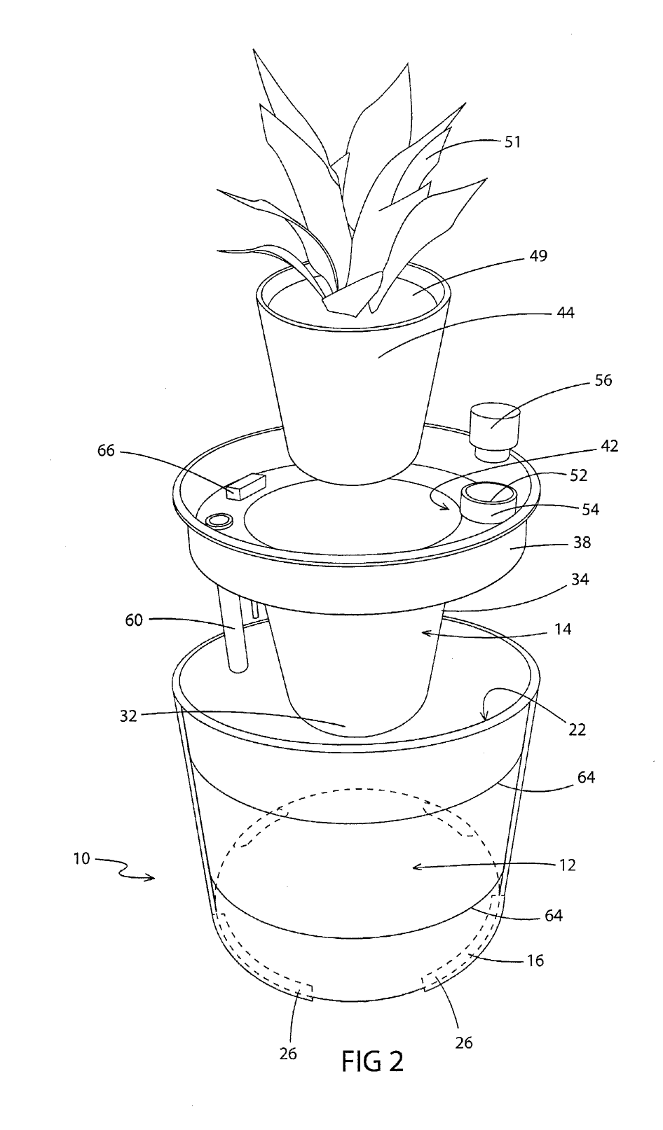

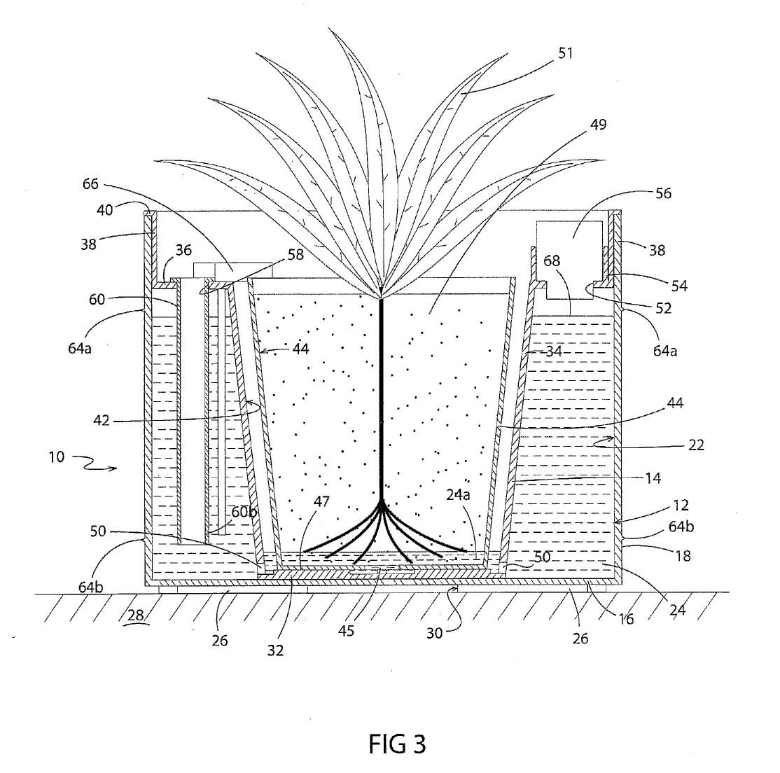

Referring to FIGS. 1-5, there is shown a self-watering plant container in accordance with the present invention and generally indicated at 10. Container 10 comprises an outer shell 12 and an inner shell 14. Inner shell 14 is smaller than outer shell 12 and nests within outer shell 12. Outer and inner shells 12,14 preferably are fabricated from a suitable thermoplastic polymeric material but can also be made from any other type of plastic, glass, acrylic, wood, ceramic, clay, metal etc. Furthermore, any of the component parts of container 10 may be made of clear or tinted plastic material or any color or combination of transparent, tinted or colored components. Furthermore, outer and inner shells 12, 14 may be of any desired shape included but not limited to cylindrical, conical, square, triangular and semicircular.

Outer shell 12 comprises a bottom wall 16 with a peripheral side wall 18 extending upwardly away therefrom and terminating in an upper edge 20. Bottom wall 16 and peripheral side wall 18 define and surround a chamber 2222 that is sized to receive inner shell 14 and to act as a reservoir for water 24. A plurality of spacers 26 extend downwardly away from bottom wall 16. Spacers 26 are adapted to rest upon a resting surface 28, creating a gap 30 between bottom wall 16 and surface 28. Gap 30 permits air to circulate beneath outer shell 12 and thereby keeping surface 28 dry and free of condensation. Spacers 26 preferably are an integral part of outer shell 12 and are of any shape and pattern, and may be disposed anywhere on bottom wall 16 that will enable outer shell 12 to be adequately supported on surface 28.

Inner shell 14 comprises a bottom wall 32 with a peripheral side wall 34 extending upwardly away therefrom. Side wall 34 preferably is frusto-conical in shape and terminates in a horizontally-oriented, annular first flange 36. It will of course be understood that any other desired shape, such as a conical shape, may also be utilized. A vertically-oriented, annular second flange 38 extends upwardly from first flange 36 and terminates in an annular lip 40. When inner shell 14 is nested into chamber 22 of outer shell 12, lip 40 rests on upper edge 20 of outer shell 12. Outer shell 12 may, alternatively rest on upper edge 20 or may interlock therewith. The engagement between outer shell 12 and inner shell 14 preferably is such that the connection permits the two components to be disassembled, yet when assembled provides an air tight connection between them. An appropriate sealant may also be applied between upper edge 20 and lip 40 to ensure this air tight connection. Inner shell 14 defines a cavity 42 that is shaped to receive a flower pot 44 therein. Flower pot 44 is a standard or regular flower pot of the type that includes an opening 45 in a bottom wall 47 thereof. Bottom wall 32 of inner shell 14 includes a plurality of raised ribs 46 that are separated from each other by depressions 48. Ribs 46 may be of any suitable size and shape and are positioned so that flower pot 44 may rest thereon.

Side wall 34 of inner shell 14 defines a plurality of channels 50 therein. Channels 50 extend directly between chamber 22 and cavity 42 and permit water 24 to flow between chamber 22 and cavity 42. Depressions 48 ensure that water 24a in cavity 42 will flow into the region between bottom wall 32 of inner shell 14 and bottom wall 47 of flower pot 44. The opening 45 in flower pot 44 allows water 24a from cavity 42 to seep into flower pot 44 and move upwardly in the soil 49 through capillary action. The roots of the plant 51 growing in soil 49 consume water from soil 49. Opening 45 also allows water retained within soil 49 to seep out of flower pot 44 and into cavity 42 if flower pot 44 is watered directly into soil 49 and there is little to no water in chamber 22 and chamber 42.

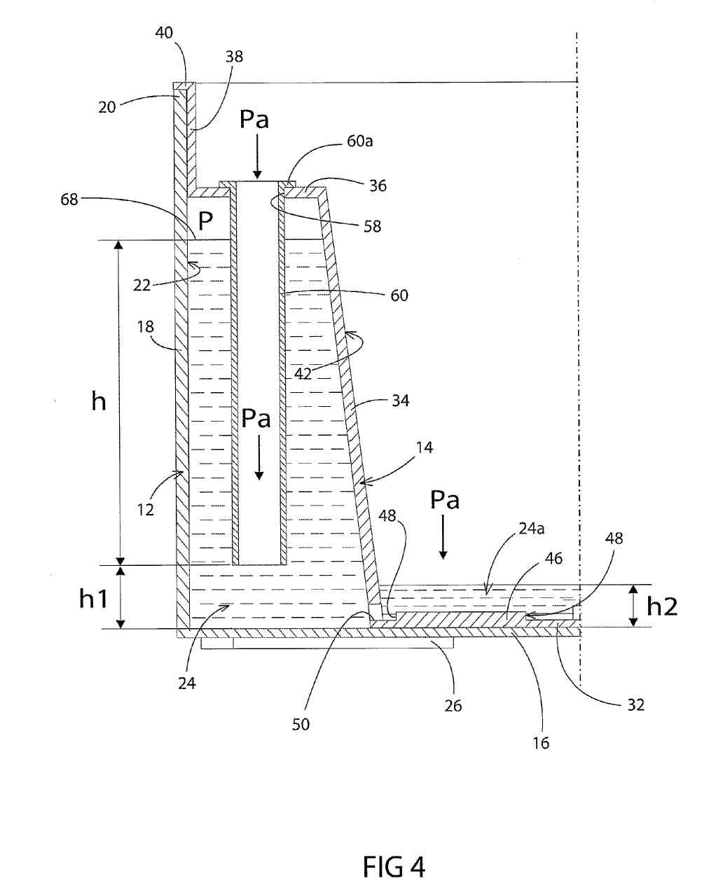

The first flange 36 of inner shell 14 defines a first aperture 52 therein. A rim 54 preferably extends upwardly and outwardly from first flange 36 and surrounds first aperture 52. A plug 56 is received in first aperture 52 to close off access to chamber 22. Rim 54 provides a guide when filling with water and helps support plug 56 when inserted in first aperture 52. First flange 36 further defines a second aperture 58 therein. An elongated, hollow tube 60 extends through second aperture 58 and into chamber 22 when inner and outer shells 14,12 are engaged with each other. Tube 60 has an upper end 60a that engages the exterior surface of first flange 36. Upper end 60a is an annular lip but may be any suitable connection between first flange 36 and tube 60. This connection must provide an airtight seal around the upper end 60a of tube 60. Tube 60 has a second end 60b that is disposed within chamber 22 and is spaced a distance h1 (FIG. 4) from bottom wall 16 of outer shell 12. Tube 60 includes a longitudinal bore 62 that acts as a passageway for air so that tube 60 functions as a breather in chamber 22. Tube 60 terminates proximate the bottom wall 16 of outer shell 12 in a region that typically will be below the level of water retained in chamber 22. Without tube 60, chamber 22 would be substantially air tight and a vacuum effect would resist the flow of water through channels 50 from chamber 22 through to cavity 42. Tube 60 permits atmospheric pressure to regulate the water levels in chamber 22 and cavity 42.

Container 10 may further be provided with a water level indicator of some suitable type. Outer shell 12 may include indicators 64 on side wall 18 thereof to indicate a maximum and a minimum water level in chamber 22. The indicators 64a, 64b may take the form of a raised or colored line. Alternatively, or additionally, container 10 may include an electronic sensor and display 66 to measure and indicate the water level in chamber 22.

Container 10 is used in the following manner. Plug 56 is removed from first aperture 52. Water is introduced through first aperture 52 and into chamber 22 until the water level 68 reaches the maximum water level indicator 64a. Water will flow into bore 62 of tube 60 during filling of chamber 22. Water level in cavity 42 will increase slightly during filling of chamber 22. Once sufficient water has been added to container 10, plug 56 is reinserted into first aperture 52 to seal access to chamber 22. Water level 68 in chamber 22 is at a distance “h+h1” (FIG. 4) from bottom wall 16 of outer shell 12. A quantity of water 24 from chamber 22 flows through apertures 50 in inner shell 14 and accumulates in cavity 42 to a height of h2 from the bottom wall 16. A lesser quantity of water flows from cavity 42 through opening 45 in flower pot 44 and into the soil 49. The water rises upwardly through soil 49 by capillary action until the system reaches a state of equilibrium.

The plant 51 withdraws water from the soil 49 in flower pot 44 and some of the water therein also evaporates. As water is consumed from soil 49 by plant 51 and by evaporation, the equilibrium in the system is disturbed and water is drawn slowly into the soil 49 from cavity 42, and subsequently from chamber 22. As this continues, the water level 68 is lowered in chamber 22 so that the size of h (FIG. 4) decreases. This equilibrium disturbance will be maintained until the water level 68 in the chamber 22 drops below the second end 60b of tube 60. During filling, the water level in chamber 22 will be equal to the water level in bore 62 of tube 60. After plug 56 is reinserted, the water level in bore 62 decreases first and drops reaching the second end 60b of tube 60. After water level in bore 60 reaches second end 60b of tube 60, water consumption begins from water chamber 22 and water level is decreasing in chamber 22 due to water consumption by plant 51. After water level 68 in chamber 22 drops below the second end 60b of tube 60 reaching h1 (FIG. 4) water level 68 and water level 24a will equalize, h1=h2.

The length and dimensions of the bore 62 of tube 60 play a factor in the equilibrium of the system. The Applicant believes that the system operates using the principles of Bernoulli's equation. The hydrostatic equation is based on the assumption that as there is very slow water consumption by plant 51, the rate of water flow through apertures 50 is sufficiently close enough to a standstill condition that in a given time period, such as 1 second, there is no water consumption inside cavity 42 of inner shell 14. Based on this assumption and using the illustration of FIG. 4, the following equations apply:

Pa=atmospheric pressure

P=air pressure inside the chamber

h, h1, h2=water column heights/hydrostatic pressure

g=gravity

μ=resistance in apertures and water surface strain

ξ=water specific density

Pa+ξ gh2+μ=Pa+ξ gh1 (1)

Pa−ξ gh1=P+ξ gh (2)

Due to plant water consumption, the quantity of water h2 in cavity 42 is decreasing. This fact creates a condition when the equilibrium of equation (1) is disturbed.

Pa+ξ gh2+μ<Pa+ξ gh1

Water 24 from the chamber 22 seeps through channels 50 and into cavity 42 of inner shell 14. Simultaneously, air enters through tube 60 into chamber 22 until the conditions of equation (1) and (2) are not fulfilled and equilibrium is established again. Due to plant water consumption, this slow process will continue until the water level 68 reaches end 60b of tube 60.

It has been found through experiment that container system 10 functions well when bore 62 of tube 60 has an 8 mm inside diameter, the end 60b of tube 60 is disposed 7 mm above apertures 50, and inner shell 14 has four apertures 50 that are each 2 mm in diameter.

Sensor 66, if provided, has a probe that extends through a third aperture in first flange 36 and into chamber 22 to monitor the water level 68 therein. When the water level 68 reaches a preset minimum amount, sensor 66 transmits a signal, such as an instant message, to a remote electronic device such as to a preset phone number. The message will indicate to the receiver that the water level in container 10 is low. The message may, of course, include any other pertinent information, such as which of several self-watering containers is transmitting the signal, how much water remains in the container etc. The message may be repeated at specified time intervals and for a preset time period. The message is repeated until container 10 is refilled or sensor 66 is disabled or cleared. This disablement or clearing can be done remotely from the preset phone number.

Water dosage from this system is optimum at all times and is regulated by the plant's own water consumption. Water flows from chamber 22 into cavity 42 and directly into opening 50 in flower pot 44. Container 10 does not utilize any intermediary such as a wick, soil stand or float mechanism to regulate water flow from chamber 22 into flower pot 44.

While the first preferred embodiment has been illustrated and described as an outer and inner shell that are joined to each other at the upper ends of the side walls it will be understood that outer and inner shells may be molded with blow-molding technology to form a single, integral, unitary member (not shown) with apertures 58, 52 and 50 formed therein. Furthermore, the bottom of the inner shell of such a unitary member may or may not be resting on the interior surface of the outer shell thereof.

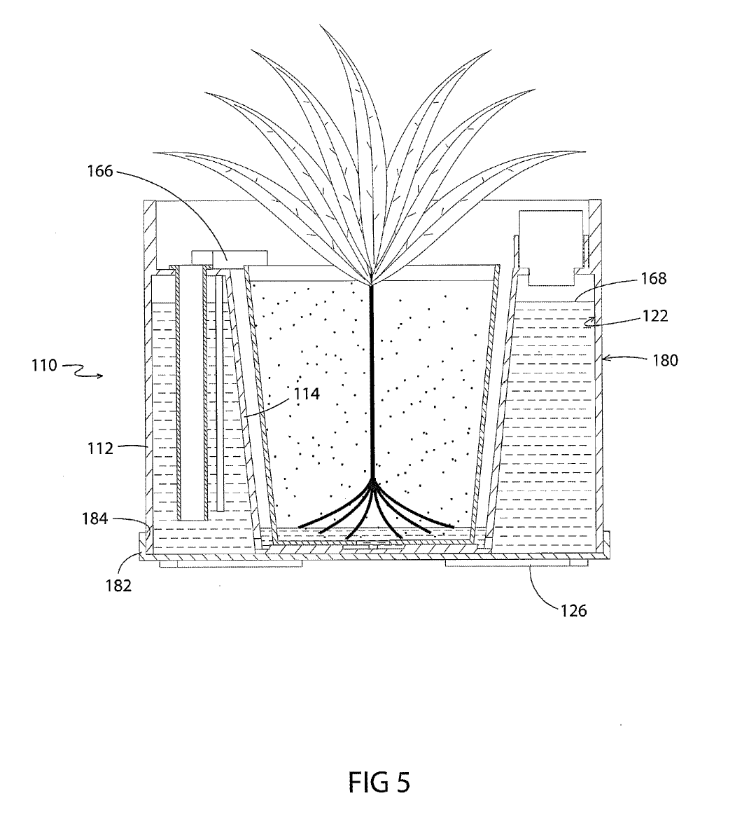

A second embodiment of a self-watering plant container in accordance with the present invention is shown in FIG. 5 and generally indicated at 110. The components of container 110 are substantially identical to those of container 10 with the exception that the outer and inner shells 112, 114 are molded with blow-molded technology to form a single, integral unitary unit 180 with apertures 58, 52 and 50 formed therein; and having a large opening at a bottom end thereof. A cap 182 is provided to close off the large opening, thereby closing off container 110 and creating a watertight chamber therein. Cap 182 interlockingly engages a bottom edge 184 of unit 180. Spacers 126 are provided on a bottom surface of cap 182 and serve the same purpose as spacers 26 in container 10. A probe from sensor 166 may extend through a third aperture in the upper surface of unit 180 and into the water chamber to monitor the level of water 168 therein.

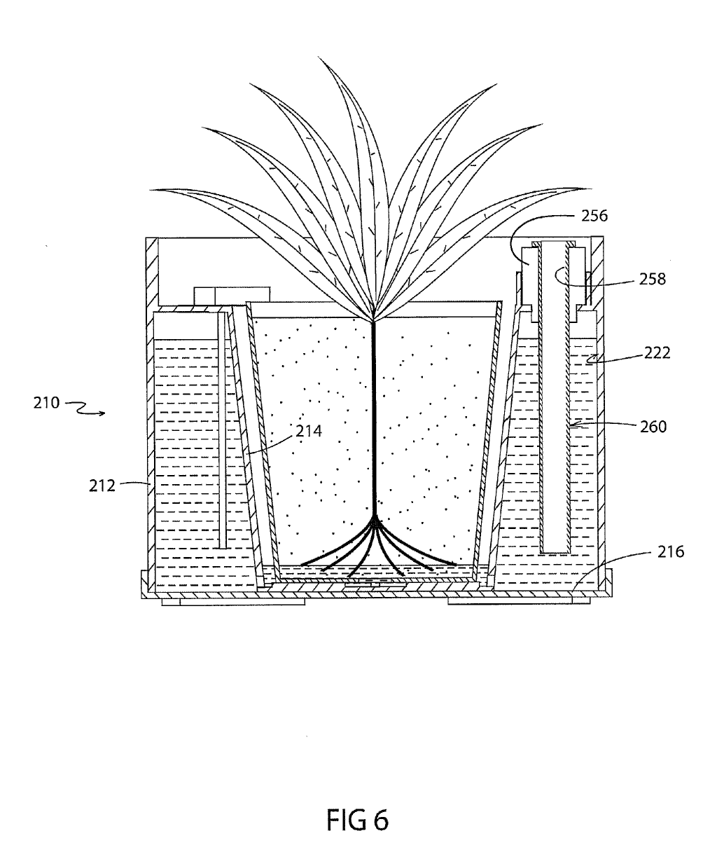

A third embodiment of a self-watering plant container in accordance with the present invention is shown in FIG. 6 and generally indicated at 210. The components of container 210 are substantially identical to those of either container 10 or container 110 (as illustrated) with the exception that the second aperture 258 is formed in plug 256. Tube 260 is sealingly connected to the plug 256 and extends downwardly therefrom into the chamber 222 between outer shell 212 and inner shell 214. Tube 260 terminates a spaced distance away from bottom wall 216 of container 210.

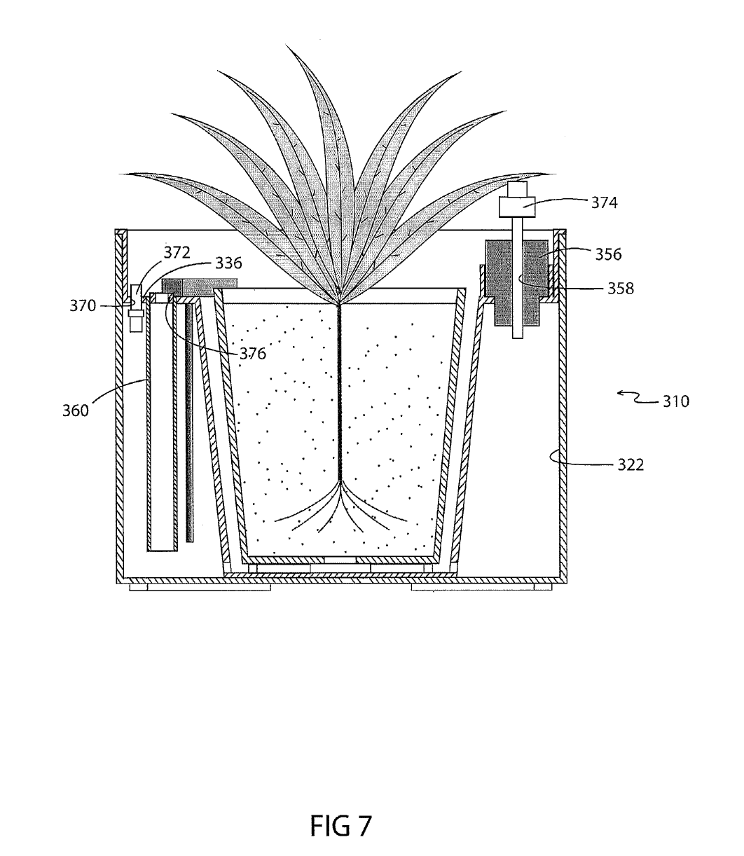

A fourth embodiment of a self-watering plant container in accordance with the present invention is shown in FIG. 7 and is generally indicated at 310. The inner and outer shells 314, 312 of container 310 may be joined together or integrally formed as previously described. Container 310, however, also includes an additional aperture 370 defined in first flange 336. Aperture 370 sealingly receives a check-valve 372 therein. Check-valve 372 functions as both a maximum water level indicator and as a water overflow valve. The plug 356 utilized in container 310 may also be provided with an aperture 358 therethrough and a filling valve 374 may be sealingly received through aperture 358. A pressurized water source (not shown) may be connected to filling valve 374 to rapidly introduce water into chamber 322. In this embodiment of the invention, water can alternatively be introduced into chamber 322 through tube 360 by attaching a pressurized water source to an adapter 376 engaged with tube 360.

It will be understood that container 10 does not need to retain a flower pot 44 but can instead have the soil 49 and plant 51 retained directly within cavity 42. In this instance, it will be preferable to include a sponge type of material (not shown) resting on wall 32 so that apertures 40 do not become clogged with soil 49.

It will further be understood that apertures 52 and 58 may be formed anywhere on the outer surface of container 10 that will permit the device to function as described above.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. A self-watering plant container for retaining a flower pot therein, said container comprising:
a base;
a cavity formed in an outer wall of the base; said cavity being adapted to retain a flower pot therein;
an interior chamber defined within the base, said chamber being adapted to retain a quantity of water therein;
at least one channel defined in the outer wall between the chamber and the cavity;
a first aperture defined in the outer wall of the base and providing ingress into the chamber; said first aperture being adapted to permit introduction of water into said interior chamber;
a second aperture defined in the outer wall of the base and providing ingress into the chamber; said second aperture being adapted to permit introduction of air into the interior chamber;
a hollow tube extending inwardly through the second aperture and into the interior chamber.

2. The self-watering plant container as defined in claim 1, wherein said base includes an upper surface and the first and second apertures are both defined in the upper surface; and wherein said hollow tube extends downwardly from the upper surface of the base and terminates a spaced distance from the bottom interior surface of the base.

3. The self-watering plant container as defined in claim 1, wherein said hollow tube is engaged at an upper end thereof to the upper surface of the base.

4. The self-watering plant container as defined in claim 3, wherein the hollow tube is engaged to the upper surface of the base via an annular lip; and wherein said annular lip rests on the upper surface of the base.

5. The self-watering plant container as defined in claim 1 further comprising a closure, said closure being received within the first aperture to seal the same.

6. The self-watering plant container as defined in claim 5, wherein the second aperture is formed in said closure; and wherein said hollow tube extends downwardly from said closure into the chamber.

7. The self-watering plant container as defined in claim 1, wherein the base comprises:
an outer shell; having a bottom wall and a peripheral side wall extending upwardly away therefrom; and
an inner shell that nests within and is engaged with said outer shell; said inner shell having a bottom wall and a peripheral side wall extending upwardly away therefrom; said bottom and side walls of the inner shell defining the cavity thereinbetween; and wherein the chamber is defined between the bottom wall of the outer shell and the peripheral side walls of both the inner and outer shells.

8. The self-watering plant container as defined in claim 7, wherein the bottom wall of the inner shell abuts the bottom wall of the outer shell.

9. The self-watering plant container as defined in claim 8, wherein a bottom end of the tube is positioned a spaced-distance above the bottom wall of the inner shell.

10. The self-watering plant container as defined in claim 7, wherein the at least one channel between the chamber and the cavity is defined in the peripheral side wall of the inner shell.

11. The self-watering plant container as defined in claim 10, wherein a bottom end of the tube is positioned a spaced distance above the at least one channel.

12. The self-watering plant container as defined in claim 1, wherein base includes an interior bottom wall that defines the cavity; and wherein the base further comprises a plurality of ribs extending upwardly from the interior bottom wall; said ribs being adapted to support a bottom end of the flower pot a spaced distance away from the interior bottom wall of the base.

13. The self-watering plant container as defined in claim 12, further comprising at least one depression formed between the ribs; and
wherein said at least one depression is positioned to permit water in the cavity to flow into an opening in a bottom end of a flower pot resting on the ribs.

14. The self-watering plant container as defined in claim 1, further comprising a plurality of feet extending outwardly away from the base, said feet being adapted to support the base on a resting surface.

15. The self-watering plant container as defined in claim 1, further comprising a water-level indicator provided on the base to indicate the level of the water within the chamber.

16. The self-watering plant container as defined in claim 15, wherein the water-level indicator comprises a pair of spaced apart markings on an exterior surface of the base to indicate a maximum and minimum level of water within the chamber.

17. The self-watering plant container as defined in claim 15, wherein the water-level indicator comprises an electronic sensor.

18. The self-watering plant container as defined in claim 17, wherein the electronic sensor is adapted to transmit a signal to a remote electronic device when the water level in the container drops below a present minimum amount.

19. The self-watering plant container as defined in claim 15, wherein the water-level indicator further includes a display screen; and wherein said display screen is adapted to indicate data about the plant retained within the container and statistical data about the watering of that plant.

20. The self-watering plant container as defined in claim 1, wherein the base includes:
an upper wall defining a cavity therein that is adapted to receive soil and a plant therein; wherein said soil and plant are received therein in a manner comprising one of directly received into the cavity and received within a plant-retaining flower pot; and wherein said upper wall of the base has a peripheral edge;
a peripheral side wall extending downwardly from the peripheral edge of the upper wall and terminating a distance away therefrom in a bottom edge;
a cap that interlocking engages the bottom edge of the side wall; whereby the upper wall, side wall and cap define an interior chamber thereinbetween that is adapted to retain a quantity of water therein.

21. The self-watering plant container as defined in claim 20, wherein the first and second apertures are defined in the upper wall, and wherein the tube extends downwardly from the upper wall and terminates a distance away from an interior surface of the cap.

22. The self-watering plant container as defined in claim 19, wherein the upper wall and peripheral side wall are formed as a single, integral component using blow-molding technology.

23. The self-watering plant container as defined in claim 20, further comprising an electronic sensor having a portion thereof extending inwardly from the upper wall and into the chamber; said electronic sensor being adapted to transmit a signal to a remote electronic device when the water level in the chamber drops below a present value.

24. The self-watering plant container as defined in claim 23, wherein the electronic sensor is preset to transmit a signal for a predetermined period of time.

25. The self-watering plant container as defined in claim 1, further comprising a check-valve that is sealingly engaged with the base; said check-valve being adapted to indicate a maximum water level and provide an overflow outlet for said interior chamber.

26. The self-watering plant container as defined in claim 1, further comprising one of a filler adapter and a filler valve that is adapted to be connected to a pressurized water source for rapid introduction of water into the interior chamber.

27. The self-watering plant container as defined in claim 26, wherein said filler adapter is engaged with an upper end of said hollow tube.

28. The self-watering plant container as defined in claim 26, further comprising a closure that is selectively engageable in said first aperture to seal the same; and wherein the filler valve is sealing engaged with said closure and extends into the interior chamber of the container.
